(19) United States
(12) Patent Application Publication
(10) Pub. No.: US 2007/0061367 A1
(43) Pub. Date: Mar. 15, 2007

(54) Method and apparatus for displaying accumulated time code in recording/reproducing of content files

(75) Inventor: Byung-gu Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/519,129

(22) Filed: Sep. 12, 2006

(30) Foreign Application Priority Data
Sep. 12, 2005 (KR) 10-2005-0084648

(51) Int. Cl. G06F 17/00

(52) U.S. Cl. 707/104.1

(57) ABSTRACT

A method and apparatus for displaying an accumulated time code value when content files are recorded or reproduced in succession are provided. The method of displaying an accumulated time code when content files are recorded in succession includes the steps of checking whether previously created content files exist, and, if previously created content files exist, defining an accumulated time code value obtained by summing time codes of the previously created content files. The accumulated time code value is set as an initial value, and a recording time count beginning at the initial value when current content is recorded is displayed. Accordingly, when content files are recorded or reproduced in succession, an accumulated recording or reproducing time of the content files is presented to the user.

### CROSS-REFERENCE TO RELATED PATENT APPLICATION

This application claims the benefit under 35 U.S.C. § 119(a) of Korean Patent Application No. 10-2005-0084648, filed on Sep. 12, 2005, in the Korean Intellectual Property Office, the entire disclosure of which is hereby incorporated by reference.

### FIELD OF THE INVENTION

The present invention relates to a method and apparatus for recording and reproducing content. More particularly, the present invention relates to a method and apparatus in which a time code is provided as an accumulated value when content files are continuously recorded or reproduced.

### DESCRIPTION OF THE RELATED ART

In general, when recording content, any of various kinds of digital recording/reproducing devices, such as digital cameras, PC cameras, camcorders, MP3 players, voice recorders, and the like, store the recorded content in a file using a predetermined encoding scheme. For each content file, the recording date, the time of the content, and a time code, which is the length of the recorded content, can also be stored.

The time code includes a count value and a time value. The count value indicates the content recording time for each file. The time value is obtained by counting time from 0 for each content file, for example, 01:45:34 (1 hour 45 minutes 34 seconds). The time code can be stored together with the file.

When a content file recorded as described above is reproduced, time information for every moment counted from 0 in a predetermined time unit (units of seconds are commonly used) can be displayed with the reproduced content by being synchronized with the reproduced content. A maximum or final time code value displayed when the content file is fully reproduced is equal to a time code value obtained when the content file was recorded.

Using any conventional content recording/reproducing device, a user can record content file(s) in succession, and create a playlist by selecting some of the recorded and stored content files and reproducing the selected content files in the playlist in succession. When content files are consecutively recorded/reproduced, the conventional content recording/reproducing device simply displays a time code value, which is the length of time corresponding to the length of the content file, as a maximum value by displaying a time code reset to the length of a new file every time a new file is recorded/reproduced, regardless of whether content files are recorded/reproduced consecutively or individually.

Thus, a conventional content recording/reproducing device does not provide a time code corresponding to a total recording time of consecutive content files or a time code corresponding to a total reproducing time of files contained in a playlist, and a user must compensate for the lack of available of total recording/reproducing time.

Accordingly, there is a need for an improved method for displaying a time code value which represents an accumulated total recording/reproducing time for successive files.

### SUMMARY OF THE INVENTION

An aspect of the present invention is to address at least the above problems and/or disadvantages and to provide at least the advantages described below. Accordingly, an aspect of the present invention is to provide a method and apparatus for displaying an accumulated time code value when content files are recorded or reproduced in succession.

According to an aspect of the present invention, a method of displaying an accumulated time code when content files are recorded in succession is provided. The method includes the step of checking whether previously created content files exist. If previously created content files exist, an initial value is set to an accumulated time code value obtained by summing time codes of the previously created content files. The recording time count, beginning at the initial value, is displayed when current content is recorded.

The method may further comprise the step of setting the initial value to 0, if previously created content files do not exist.

The method may be performed in an accumulated time code display mode.

According to another aspect of the present invention, a method of displaying an accumulated time code when content files are reproduced in succession is provided. The method includes the steps of accumulating time codes of previously reproduced content files, and displaying a time code count beginning at the accumulated time code value when current content is reproduced.

The method may further comprise the step of setting a display mode to an accumulated time code display mode.

According to another aspect of the present invention, a method of displaying an accumulated time code during playlist reproduction is provided. The method includes the step of receiving a selection of content files for a playlist, displaying a time code count beginning at 0 when an initial content file in the playlist is reproduced, and displaying the time code count beginning at a final time code of a previously reproduced content file for subsequently reproduced content files.

According to another aspect of the present invention, an apparatus for displaying an accumulated time code when content files are recorded in succession is provided. The apparatus comprises a first memory for storing respective time codes of recorded and created content files, a computation unit for calculating an accumulated value by summing the time codes stored in the first memory, a counter for counting a recording time beginning at the accumulated value when current content is recorded, and a display unit for displaying a count value of the counter.

The apparatus may further comprise a second memory for storing an address of a time code of a content file stored in the first memory when the content file is created.

The computation unit may calculate the accumulated value by summing all the time codes in respective addresses of the first memory indicated by the second memory in an accumulated time code display mode.

According to another aspect of the present invention, an apparatus for displaying an accumulated time code when content files are reproduced in succession is provided. The apparatus comprises a computation unit for calculating an accumulated value by summing time codes of previously reproduced content files, a counter for performing a time code count beginning at the accumulated time code value when current content is reproduced, and a display unit for displaying a count value of the counter while the content is being reproduced.

The apparatus may further comprise a first memory for storing respective time codes of recorded content files in predetermined addresses, and a second memory for storing addresses of time codes of content files previously reproduced from the first memory.

The computation unit may calculate a value obtained by accumulating time codes in addresses of the first memory corresponding to addresses stored in the second memory.

According to another aspect of the present invention, a method of displaying a time code while processing (such as recording or reproducing) a content file is provided. The method includes the steps of determining whether previously processed content files exist. If previously processed content files do not exist, an initial value is set to zero. If previously processed content files exist, an accumulated value of content files is calculated. Which time code display mode is set is set is determined, and, if the time code display mode is an accumulated time code display mode, the initial value is set to the accumulated value of content files.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic block diagram of an apparatus for displaying an accumulated time code when recording content files according to an exemplary embodiment of the present invention;

FIG. 2 is a schematic block diagram of an apparatus for displaying an accumulated time code when reproducing content files according to an exemplary embodiment of the present invention;

FIG. 3 is a flowchart of a method of displaying an accumulated time code when recording content files according to an exemplary embodiment of the present invention;

FIG. 4 is a flowchart of a method of displaying an accumulated time code when reproducing content files according to an exemplary embodiment of the present invention;

FIG. 5 is a flowchart of a method of displaying an accumulated time code during playlist reproduction according to an exemplary embodiment of the present invention; and

FIG. 6 illustrates the operation of the components illustrated in FIG. 2 when a time code is displayed during playlist reproduction according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

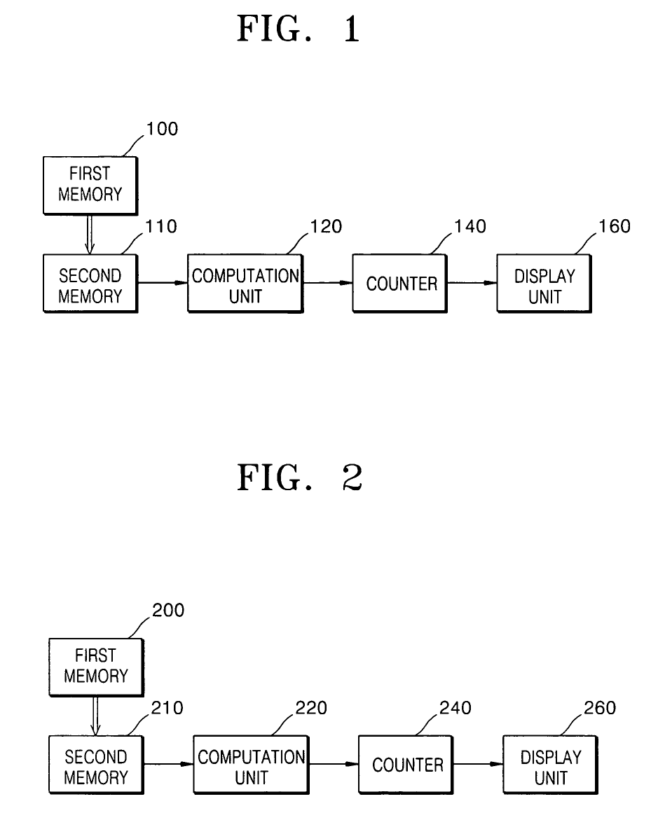

FIG. 1 is a schematic block diagram of an apparatus for displaying an accumulated time code when recording content files according to an exemplary embodiment of the present invention.

Referring to FIG. 1, the apparatus includes a first memory 100, a computation unit 120, a counter 140, and a display unit 160.

The first memory 100 stores respective time codes of recorded and created content files.

The computation unit 120 calculates an accumulated value by summing the time codes stored in the first memory 100.

The counter 140 outputs a real-time count value obtained by counting recording time in predetermined time units (for example, seconds) when current content is recorded. In a general content recording mode, the counter 140 is reset to 0 when recording of new content starts and outputs a count value increasing from 0 while the new content is being recorded. If a user commands the apparatus to display an accumulated content recording time (that is, the user sets the mode to an accumulated time code display mode), the counter 140 starts at a count value equal to an accumulated time code value for already recorded files calculated by the computation unit 120 when recording of the new content starts and outputs the count value.

The display unit 160 displays the count value. If the content being recorded is a moving picture, the display unit 160 displays a count value in an on-screen display (OSD) pattern superimposed on the content being recorded.

In an exemplary embodiment of the present invention, the apparatus can further include a second memory 110 and an image processing unit (not shown) for image signal processing the count value output from the counter 140 and displaying the image signal processed count value through the display unit 160. The second memory 110 stores addresses of the first memory 100 in which time codes of content files created by successive content recording are stored. The computation unit 120 sums only time codes stored in the first memory 100 corresponding to addresses stored in the second memory 110.

Using the apparatus, a user can receive recording time information of content files recorded and created in succession while recording content.

The apparatus for displaying an accumulated time code when recording content files according to an exemplary embodiment of the present invention can be implemented in any content recording and creating device.

FIG. 2 is a schematic block diagram of an apparatus for displaying an accumulated time code when reproducing content files according to an exemplary embodiment of the present invention.

Referring to FIG. 2, the apparatus includes a computation unit 220, a counter 240, and a display unit 260.

The computation unit 220 calculates an accumulated time value by accumulating time codes of previously reproduced content files.

The counter 240 outputs a real-time count value obtained by counting a reproducing time in predetermined time units (for example, seconds) when content is reproduced. In a general content reproducing mode, the counter 240 is reset to 0 when reproducing of new content starts and outputs a count value increasing from 0 while the new content is being reproduced. If a user commands the apparatus to display an accumulated content reproducing time (in an accumulated time code display mode), the counter 240 starts at a count value equal to an accumulated time code value for already reproduced files calculated by the computation unit 220 when reproducing of the new content starts, and outputs the count value.

The display unit 260 displays the count value. If content being reproduced is a moving picture, the display unit 260 displays a count value in an OSD pattern superimposed on the content being reproduced.

In an exemplary embodiment of the present invention, the apparatus can further include an image processing unit (not shown) for image signal processing the count value output from the counter 240 and displaying the image signal processed count value through the display unit 260, a first memory 200, and a second memory 210.

The first memory 200 stores time codes of all recorded and created content files at respective addresses.

The second memory 210 stores addresses of the first memory 200 in which time codes of previously reproduced content files are stored. The computation unit 220 sums only time codes stored in the first memory 200 corresponding to addresses stored in the second memory 210.

Using the apparatus, a user can receive reproducing time information accumulated while content files are reproduced in succession.

The apparatus for displaying an accumulated time code when reproducing content files according to an exemplary embodiment of the present invention can be implemented in any content reproducing device.

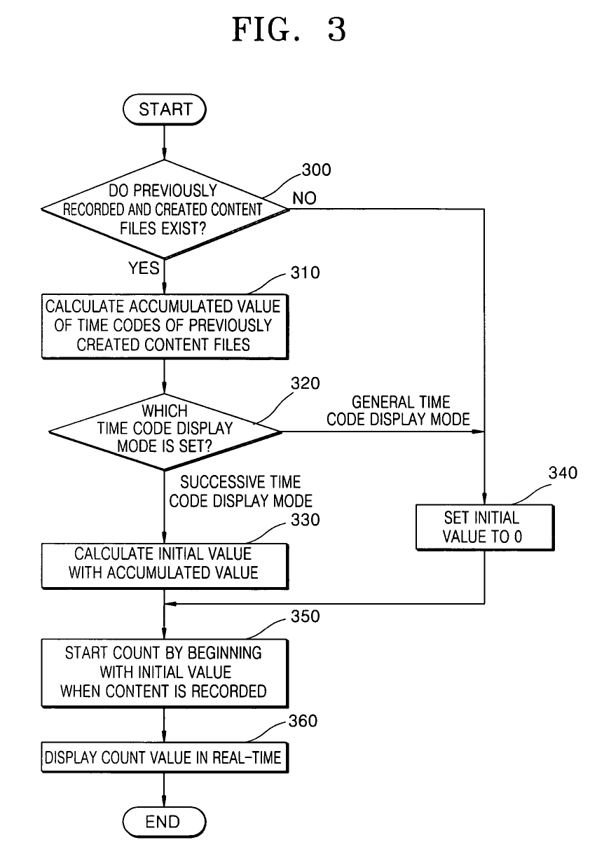

FIG. 3 is a flowchart of a method of displaying an accumulated time: code when recording content files according to an exemplary embodiment of the present invention. The method is performed in a predetermined content recording device.

Referring to FIG. 3, in operation 300, whether previously recorded and created content files exist is checked by determining whether previously created content files are stored in a storage medium, such as a hard disk drive (HDD), or the second memory 110, which is illustrated in FIG. 1, of the content recording device before content is recorded.

If previously created content files exist, an accumulated value of time codes of the previously created content files is calculated in operation 310. This can be performed by the computation unit 120 illustrated in FIG. 1. If previously created content files do not exist, the initial count value is set to 0 in operation 340.

A time code display mode is checked in operation 320. If the time code display mode is an accumulated time code display mode, the initial count value is set to the accumulated value obtained in operation 310 using the counter 140 illustrated in FIG. 1 in operation 330. If the time code display mode is a general time code display mode, the initial count value is set to 0 in operation 340.

When content recording starts, counting starts in predetermined time units (for example, seconds) beginning at the initial value determined in operation 330 or 340, in operation 350.

The real-time count is displayed as a recording time code (a count of recording time) in operation 360.

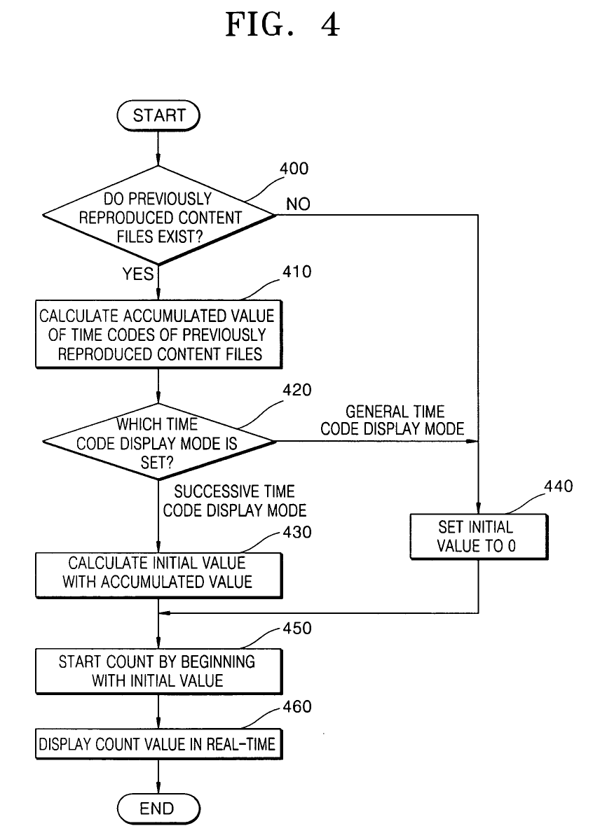

FIG. 4 is a flowchart of a method of displaying an accumulated time code when reproducing content files according to an exemplary embodiment of the present invention. The method is performed in a predetermined content reproducing device.

Referring to FIG. 4, in operation 400, before content is reproduced, addresses stored in a storage medium, such as an HDD, or the second memory 210, which is illustrated in FIG. 2, are checked to determine whether previously reproduced content files exist.

If previously reproduced content files exist, an accumulated value of time codes of the previously reproduced content files is calculated in operation 410. That is, time codes stored in the first memory 200 corresponding to the addresses stored in the second memory 210 illustrated in FIG. 2 are summed. If previously created content files do not exist, the initial count value is set to 0 in operation 440.

A time code display mode is checked in operation 420, and if the time code display mode is an accumulated time code display mode, the initial count value is set to the accumulated value obtained in operation 410, in operation 430. If the time code display mode is a general time code display mode, the initial count value is set to 0 in operation 440.

When content reproduction starts, a count value is increased by predetermined time units (for example, seconds) beginning at the initial value determined in operation 430 or 440, in operation 450.

The real-time count is displayed as a reproducing time code (a count of a reproducing time in operation 460.

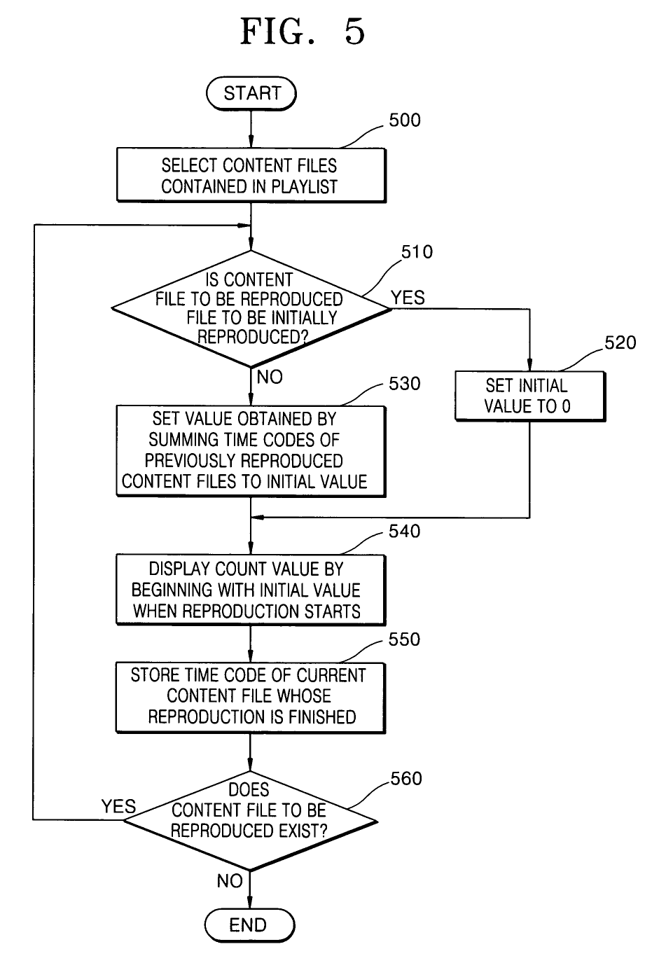

FIG. 5 is a flowchart of a method of displaying an accumulated time code during reproduction of a playlist according to an exemplary embodiment of the present invention.

Referring to FIG. 5, content files belonging to a playlist are selected in operation 500.

In operation 510, the content file is checked to determine whether the content file is the first content file to be reproduced from the playlist. If the content file to be reproduced is the first content file to be reproduced, the initial count value is set to 0 in operation 520.

If the content file to be reproduced is not the first content file to be reproduced, the initial count value is set to a value obtained by summing time codes of previously reproduced files in operation 530. Whether content to be currently reproduced is initially reproduced content can be determined by checking whether predetermined address data is stored in the second memory 210 illustrated in FIG. 2.

When reproduction of a current content file starts, a count value (a time code) of a reproducing time is displayed, beginning at the initial count value in operation 540.

When the reproduction of the current content file is finished, the time code of the current content file is stored in operation 550. This is performed by storing in the second memory 210 an address where a time code of a corresponding content file is stored in the first memory 200.

In operation 560, the playlist is checked to determine if another content file is to be reproduced. If so, operation 510 is performed again. If there is no further content file to be reproduced, the reproduction is finished.

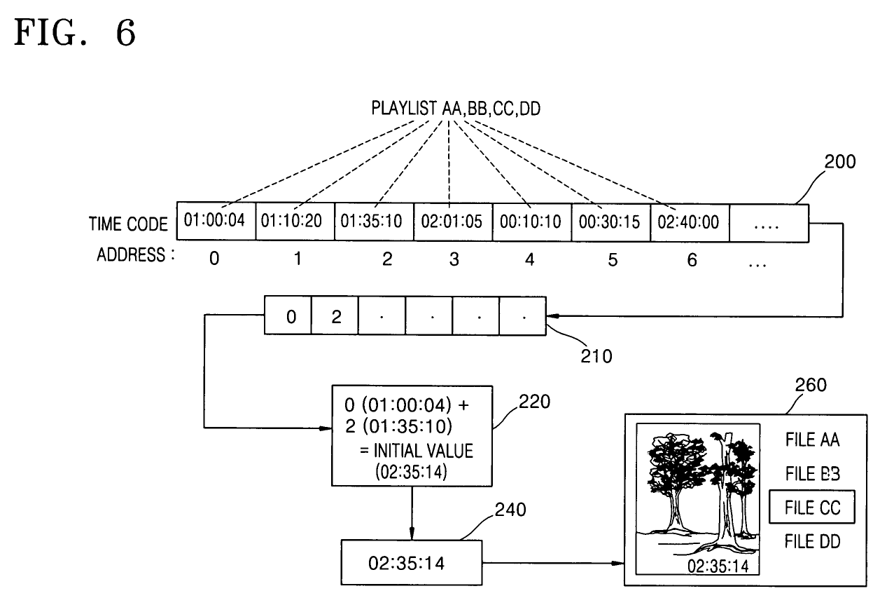

FIG. 6 illustrates the operation of the components illustrated in FIG. 2 when a time code is displayed during playlist reproduction according to an exemplary embodiment of the present invention.

Referring to FIG. 6, time codes of recorded content files are stored in respective addresses of the first memory 200. In FIG. 6, file AA, file BB, file CC, and file DD have been selected in a playlist. The file AA and the file BB have already been reproduced, and the file CC is now going to be reproduced. Addresses ‘0’ and ‘2’, which are addresses in which time codes of the files AA and BB are stored, are stored in the second memory 210. The computation unit 220 calculates 02:35:14 obtained by summing 01:00:04 and 01:35:10, which are time codes corresponding to the addresses ‘0’ and ‘2’. The counter 240 sets 02:35:14, the accumulated value obtained by the computation unit 220, to an initial count value, and outputs a real-time count value increasing from the initial count value when the file CC is reproduced. The display unit 260 displays a time code of 02:35:14, which is the initial value of the counter 240, with an initially reproduced image of content of the file CC. When the reproduction proceeds, the counter 240 starts counting as the content of the file CC is reproduced, and relevant count values are successively displayed as the time code of the display unit 260.

By using the displayed accumulated time code described above, a user can control content recording or editing time in view of total medium capacity and can easily discern accumulated reproducing time information when content is reproduced.

As described above, according to exemplary embodiments of the present invention, when content files are recorded or reproduced in succession, user satisfaction for a user using a recording or reproducing device can be enhanced. Furthermore, the usage of a storage medium can be optimized by providing an accumulated recording or reproducing time of the content files to the user.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of displaying an accumulated time code when content files are recorded in succession, the method comprising the steps of:
checking whether previously created content files exist;
if previously created content files exist, defining an initial value as an accumulated time code value obtained by summing time codes of the previously created content files; and
displaying a recording time count beginning at the initial value when current content is recorded.

2. The method of claim 1, further comprising the step of
if previously created content files do not exist, setting the initial value to 0.

3. The method of claim 1, further comprising the step of:
setting a display mode to an accumulated time code display mode.

4. A method of displaying an accumulated time code when content files are reproduced in succession, the method comprising the steps of:
accumulating time codes of previously reproduced content files; and
displaying a time code count beginning at the accumulated time code value when current content is reproduced.

5. The method of claim 4, further comprising the step of:
setting a display mode to an accumulated time code display mode.

6. A method of displaying an accumulated time code during playlist reproduction, the method comprising the steps of:
receiving a playlist of content files;
displaying a time code count beginning at 0 when an initial content file in the playlist is reproduced; and
displaying the time code count beginning at a final time code of a previously reproduced content file when a content file to be reproduced is not the initially reproduced content file.

7. An apparatus for displaying an accumulated time code when content files are recorded in succession, the apparatus comprising:
a first memory for storing time codes of recorded and created content files;
a computation unit for calculating an accumulated value by summing the time codes stored in the first memory;
a counter for counting a recording time beginning at the accumulated value when current content is recorded; and
a display unit for displaying a count value of the counter.

8. The apparatus of claim 7, further comprising:
a second memory for storing an address of a time code of a content file stored in the first memory when the content file is created.

9. The apparatus of claim 7, wherein the computation unit calculates the accumulated value by summing all the time codes in respective addresses of the first memory indicated by the second memory in an accumulated time code display mode.

10. An apparatus for displaying an accumulated time code when content files are reproduced in succession, the apparatus comprising:
a computation unit for calculating an accumulated value by summing time codes of previously reproduced content files;
a counter for performing a time code count beginning at the accumulated time code value when current content is reproduced; and
a display unit for displaying a count value of the counter while the content is being reproduced.

11. The apparatus of claim 10, further comprising:
a first memory for storing respective time codes of recorded content files at addresses; and
a second memory for storing the addresses of time codes of content files previously reproduced from the first memory.

12. The apparatus of claim 10, wherein the computation unit calculates a value obtained by accumulating time codes in addresses of the first memory corresponding to addresses stored in the second memory.

13. A method of displaying a time code while processing a content file, comprising the steps of:
determining whether previously processed content files exist;
if previously processed content files do not exist, setting an initial value to zero;
if previously processed content files exist, calculating an accumulated value of content files;
determining which time code display mode is set; and
if the time code display mode is an accumulated time code display mode, setting the initial value to the accumulated value of content files.

14. The method of claim 13, further comprising the step of:
if the time code display mode is a general time code display mode, setting the initial value to zero.

15. The method of claim 13, further comprising the steps of:
counting the time code starting at the initial value.

16. The method of claim 15, further comprising the step of:
displaying the time code.

17. The method of claim 13, wherein the previously processed content files are previously recorded content files.

18. The method of claim 16, wherein the previously processed content files are previously reproduced content files.
